(19) United States
(12) Patent Application Publication
(10) Pub. No.: US 2008/0012260 A1
(43) Pub. Date: Jan. 17, 2008

(54) Pallet dolly

(75) Inventors: Jeffrey C. Ouyang, Glenview, IL (US); Thomas M. Conway, Park Ridge, IL (US)

Correspondence Address: WELSH & KATZ, LTD, 120 S RIVERSIDE PLAZA, 22ND FLOOR, CHICAGO, IL, 60606, US

(73) Assignee: Cormark, Inc.

(21) Appl. No.: 11/485,139

(22) Filed: Jul. 12, 2006

(51) Int. Cl. B62D 21/14

(52) U.S. Cl. 280/79.11; 280/43.12

(57) ABSTRACT

A pallet dolly for storage and movement of merchandise. In one embodiment, a deck is provided having a plurality of wheels. A handle is movably connected to the deck and can be stored adjacent the deck. Attached to the pallet dolly is a brake assembly to prevent movement of the dolly.

### FIELD OF THE INVENTION

The present invention relates to pallet dollies and more specifically to pallet dollies that provide for efficient storage and movement of merchandise stored on the dollies.

### BACKGROUND OF THE INVENTION

Existing pallets are commonly used to store and move merchandise such as, for example, mechanical equipment and various products. Existing pallets are typically constructed of wood or other materials and provide a base and a top portion forming the pallet whereby the opening between the base and top portion allow for the forks of a forklift vehicle or other device to pick up and move the pallet and stored merchandise to another location. Current pallets have some inherent disadvantages in that they require a separate device to pick up and move the stored merchandise and pallet from one location to another. Often, the device required to move the pallet is not located conveniently nearby or is being used by another person for another project. One of the difficulties associated with this is that time is wasted by the person required to move the pallet and merchandise. Additionally, pallets are stored in retail-type situations such as, for example, warehouse stores where goods such as paint gallons or other merchandise are stored on the pallets. Frequently, large shelving units or storage racks with multiple shelves act to store multiple pallets at various points on the shelves. The pallets located at ground level are often accessed by store associates when assisting customers. With current pallets, the associate must bend over and reach under the storage device to access merchandise stored at the rear of the pallet or spend considerable time moving the pallet out from under the storage device. During this process, associates may be injured due to the stress their bodies encounter in the awkward position necessary to reach under the storage device and lift heavy merchandise to remove it from the rear of the pallet.

The pallet dolly of the present invention overcomes the disadvantages in existing pallet storage systems. The pallet dolly provides for storage of merchandise and allows for easy movement of the pallet dolly using a combination of a movable handle and wheels to quickly and easily move the pallet dolly from location to location without wasted time.

### BRIEF SUMMARY OF THE INVENTION

In one embodiment, the pallet dolly includes wheels which preclude the need to have a separate vehicle or device to assist with movement of the pallet dolly. The wheels provide ease of movement of the pallet dolly even when fully loaded with heavy merchandise. A moveable handle is also provided that stores inside the pallet dolly deck when the handle is not in use. Through use of the pallet dolly, it is much safer, quicker and efficient for a store associate to remove the handle of the pallet dolly, unlock the pallet dolly braking system and pull the pallet dolly from under a shelving unit for easy access of the merchandise stored on the pallet dolly. When the pallet dolly is removed from under, for example, a storage unit, the person accessing the merchandise is much less likely to injure themselves because it is considerably easier to access the stored merchandise when the pallet dolly is removed out from under the storage unit. Other applications for the pallet dolly include, but are not limited to efficient movement of products, equipment or machinery from one location to another for a variety of applications.

### BRIEF DESCRIPTION OF THE DRAWINGS

FIG. 1 is a perspective view of one embodiment of the pallet dolly;

FIG. 2 is a front view of one embodiment of the pallet dolly of FIG. 1;

FIG. 3 is a right side view of one embodiment of the pallet dolly of FIG. 1;

FIG. 4 is an underside perspective view of one embodiment of the pallet dolly of FIG. 1;

FIG. 5 is a perspective view of one embodiment of a gear braking assembly for the pallet dolly;

FIG. 6 is a perspective view of one embodiment of a brake rotor for the braking assembly of FIG. 5;

FIG. 7 is a perspective view of one embodiment of the pallet dolly of FIG. 1 shown with the handle in the storage position;

FIG. 8 is a perspective view of another embodiment of a braking assembly for the pallet dolly;

FIG. 9 is a perspective view of another embodiment of a braking assembly for the pallet dolly;

FIG. 10 is an underside perspective view of another embodiment of a braking assembly for the pallet dolly;

FIG. 11 is an underside perspective view of another embodiment of a braking assembly for the pallet dolly;

FIG. 12 is a partial cut-away side view of the braking assembly of FIG. 11;

FIG. 13A is a side view of another embodiment of a handle assembly and storage mount for the pallet dolly;

FIG. 13B is a side view of the dolly of FIG. 13A shown with the handle in the stored position;

FIG. 14 is a perspective view of another embodiment of a braking assembly for the pallet dolly; and

FIG. 15 is a perspective view of another embodiment of the braking system of FIG. 14.

### DETAILED DESCRIPTION OF THE INVENTION

While the present invention is susceptible to embodiments in various forms, there is shown in the drawings and will hereinafter be described some exemplary and non-limiting embodiments, with the understanding that the present disclosure is to be considered an exemplification for the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

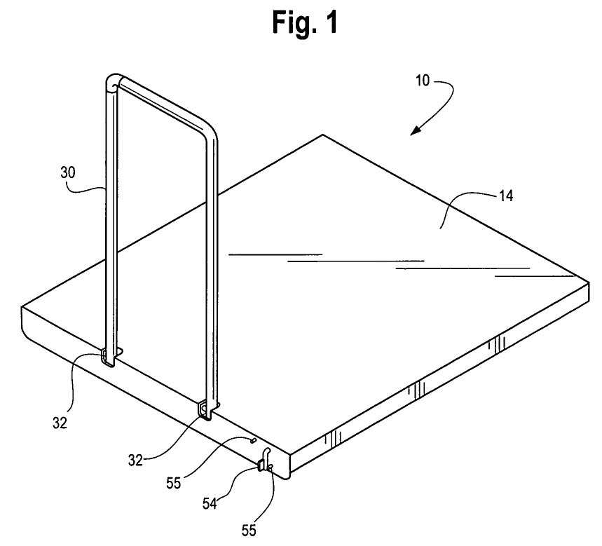

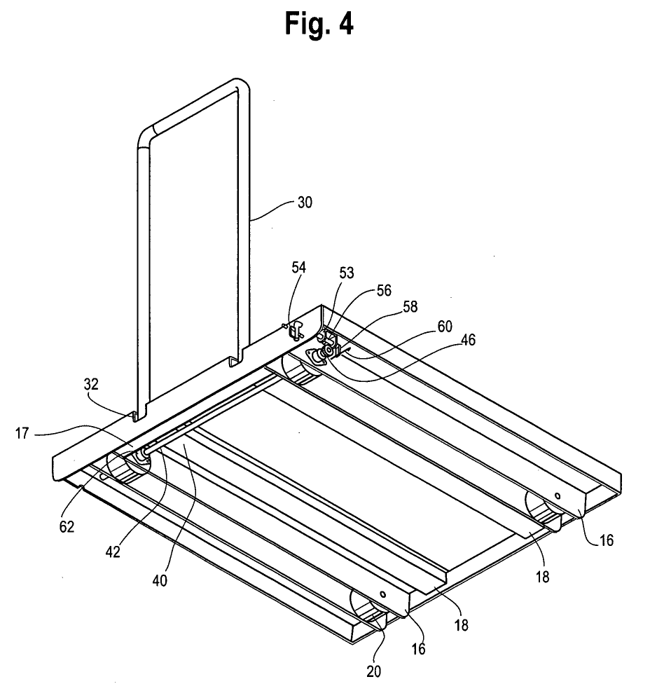

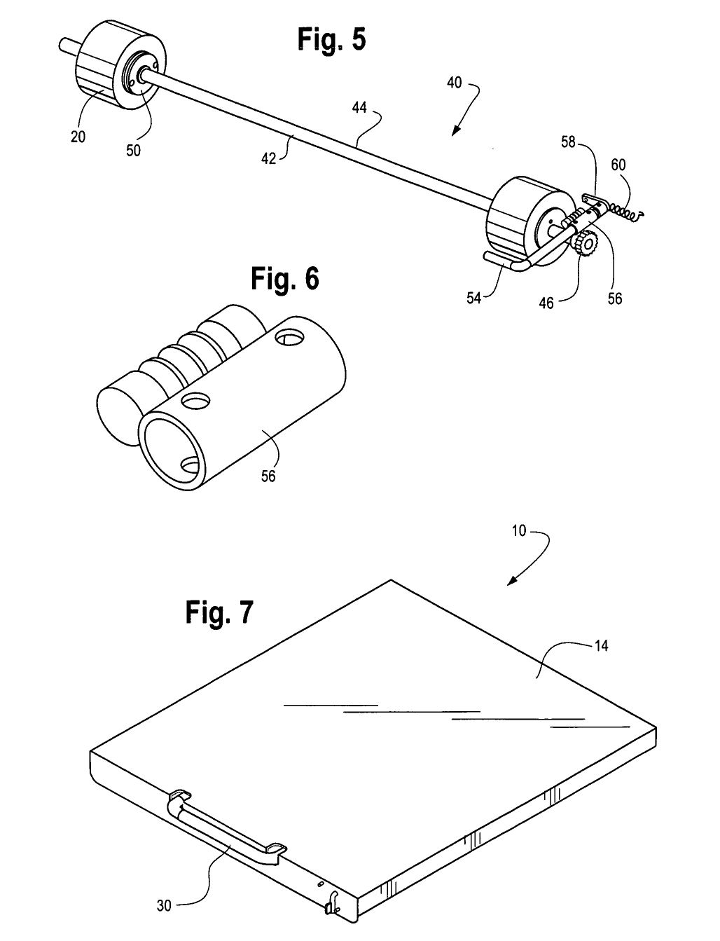

FIG. 1 is a perspective view of one embodiment of the pallet dolly 10. As shown in FIG. 1, one embodiment of the pallet dolly 10 includes a deck 14, moveable handle 30, handle holes 32, brake lever 54 and pin stops 55. Additionally, as shown in FIG. 4, one embodiment of pallet dolly 10 includes wheel channels 16 containing wheels 20, front reinforcement portions 17, handle channels 18 and gear braking assembly 40 (see FIG. 5 also).

As shown in FIGS. 4 and 5, in one embodiment, gear braking assembly 40 may comprise a shaft 42 that is fully keyed 44, gear 46, keys plate 50, shims 52, brake lever bracket 53, brake lever 54, brake rotor 56 (see also FIG. 6), brake cam 58, spring 60, and flange mount roller bearing 62.

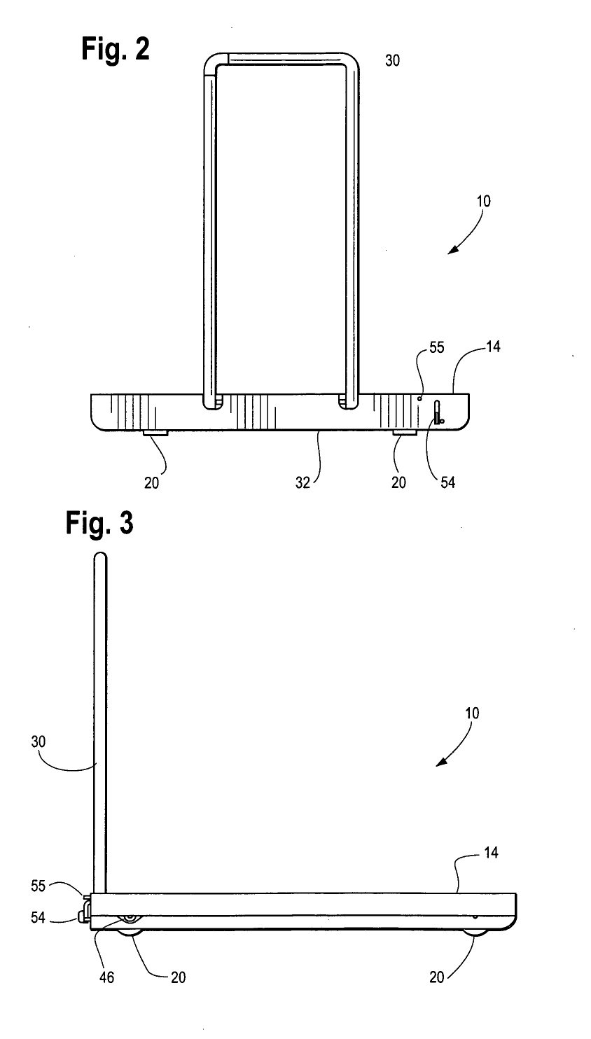

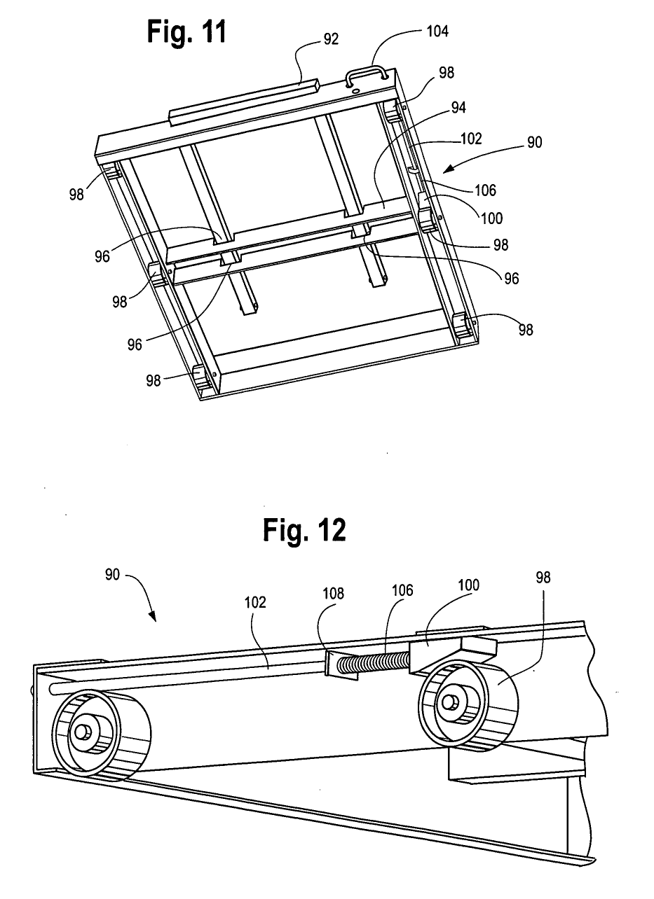

As shown in FIGS. 1, 2 and 4, handle 30 may be extended to the upright position when the pallet dolly 10 needs to be moved. Handle 30 also easily rotates about reference point holes 32. When handle 30 is in a substantially upright position the rotation of handle 30 allows for ease of movement of pallet dolly 10 and provides an ergonomical position of handle 30 with respect to pallet dolly deck 14 to minimize the associated stress on the person pulling or moving pallet dolly 10. After pallet dolly 10 has been moved to its desired stationary position, handle 30 is easily stored within the underside of deck 14. In one embodiment, handle 30 is lowered and moved into its storage position where it is maintained in a secure position within handle channels 18. FIG. 7 shows handle 30 in its storage position. In other embodiments, handle 30 can be constructed of a variety of different materials and in a variety of different shapes and sizes for the specific application required. In yet other forms, handle 30 may be provided and constructed to comprise multiple pieces that work together to move pallet dolly 10. In other forms, handle 30 may be stored in deck 14 in different ways and provide for different construction for same. One example of an alternative configuration of handle 30 and a storage assembly are shown in FIG. 11. In still yet other embodiments, the handle may be used to actuate and/or release the brake or brake system.

As shown in FIGS. 1 and 4, in one embodiment, deck 14 is comprised of a substantially flat surface to enable secure, stable storage of merchandise. As shown in FIGS. I and 4, in one embodiment, deck 14 is substantially square or rectangular in shape. In yet other embodiments, deck 14 may be any other size, shape or configuration to provide for the specific required application. For example, deck 14 may be circular shaped, triangular shaped, donut shaped, or any other shape that is required for a specific application. In yet other forms, deck 14 may include additional means for providing added traction to prevent slippage of the merchandise from deck 14. Deck 14 may also include additional removable attachments or permanent structures to assist with maintaining merchandise in a fixed position on deck 14.

As shown in FIGS. 4, 5 and 6, one embodiment of pallet dolly 10 may include a gear braking assembly 40. Gear braking assembly 40 provides for pallet dolly 10 to remain in a fixed, secured and locked non-moveable position when the pallet dolly is required to remain stationary. In one embodiment, brake lever 54 controls the actuation of gear braking assembly 40. As best shown in FIG. 5, wheels 20 are mounted on each side of keyed shaft 42. Keys plate 50 is positioned adjacent wheel 20 and provides for wheels 20 to maintain a secure rotatable movement with respect to pallet dolly 10. Gear 46 is secured to one end of shaft 42 substantially as shown in FIG. 5. Brake lever 54 is connected to brake rotor 56 adjacent brake cam 58. Spring 60 is attached to brake cam 58. To activate the braking system, brake lever 54 is rotated whereby brake rotor 56 (see FIG. 6) engages gear 46 to prevent rotation of shaft 42 thereby preventing pallet dolly 10 from moving. If brake rotor 56 and gear 46 fail to immediately engage because of, for example, improper alignment, spring 60 encourages the alignment and resulting engagement. As shown in FIG. 4, braking assembly 40 is mounted on the underside of deck 14 whereby wheels 20 are positioned within wheel channel 16 and shaft 42 is secured within wheel channels 16 by flange mount roller bearings 62. Other forms of pallet dolly 10 may use a variety of different types of braking systems.

During use, pallet dolly 10 is loaded with merchandise and positioned on the floor underneath a warehouse rack or shelf storage system. When a store associate needs to move pallet dolly 10 from under the storage system, handle 30 is removed out from deck 14 storage position and extended as shown in FIG. 1. Then, brake lever 54 is rotated or moved to unlock braking assembly 40 to enable the wheels to rotate and for the pallet dolly to freely and easily move. Once the pallet dolly is in the intended new location, brake lever 54 is moved to the locked position to lock gear braking assembly 40 to prevent pallet dolly 10 from moving. Handle 30 is then rotated, lowered and stored within wheel channels 16 on the underside of deck 14.

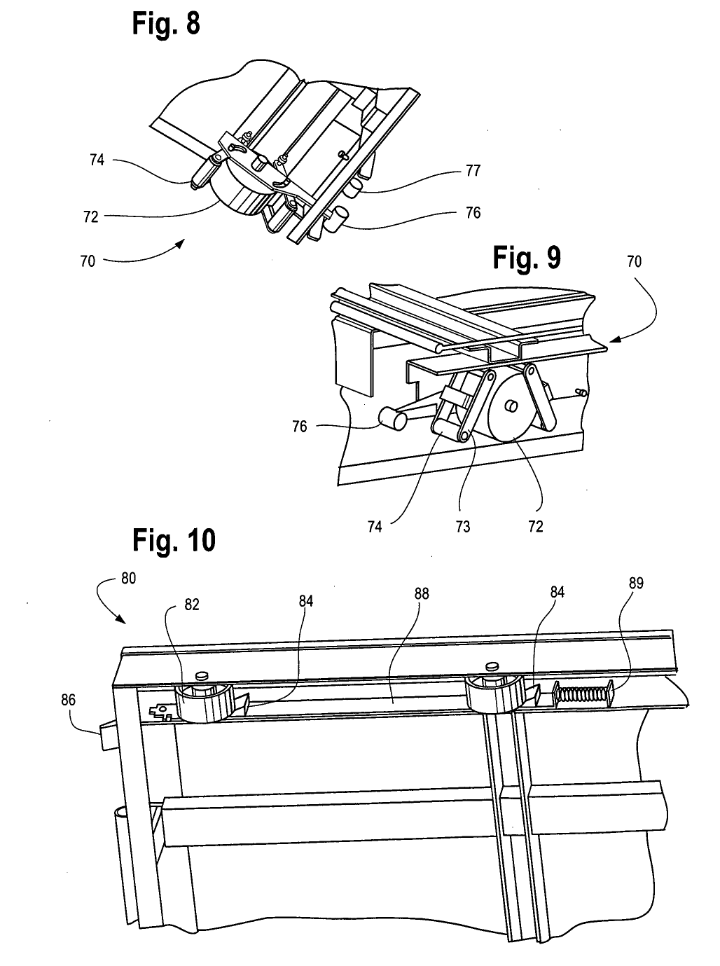

In yet other forms of pallet dolly 10, various braking assemblies may be used to prevent movement of pallet dolly when it is in its locked stationary position. An alternate embodiment of a braking assembly 70 is shown in FIGS. 8 and 9. As shown in FIGS. 8 and 9, in one embodiment, braking assembly 70 may comprise wheels 72, roller arms 73 attached to rollers 74, brake actuator lever 76 and release lever 77. During use, brake actuator lever 76 is engaged to enable rollers 74 to lock down and wedge between wheels 72 and the floor to prevent the pallet dolly from moving. To enable the pallet dolly to move, lever 77 is pushed downward and releases lever 77 thereby providing for rollers 74 to disengage from wheels 72 and allow wheels 72 to freely rotate. This combination of lever 76 and lever 77 allows for the brake to be engaged and disengaged with the same “stepping down” motion by the store associate.

Yet another braking assembly is shown in FIG. 10. As shown in FIG. 10, an alternate embodiment brake assembly 80 may comprise wheels 82, wedge lock 84, brake actuator lever 86, wedge connector 88, and spring 89. During use, brake assembly 80 may be engaged to prevent wheels 82 from rotating. A user would activate brake lever 86 and provide for one or more wedge locks 84 to engage wheels 82 thereby preventing rotation of wheels 82. To allow the pallet dolly to freely move, brake lever 86 is moved and wedge locks 84 are disengaged from wheels 82 thereby allowing the pallet dolly to freely move. Spring 89 maintains the wedge locks 84 a set distance away from wheels 84 to prevent accidental locking.

FIG. 11 shows yet another embodiment of a braking assembly 90 for the pallet dolly. FIG. 12 shows a side view of the alternate embodiment for a braking assembly 90 of FIG. 11. As shown in FIGS. 11 and 12, brake assembly 90 comprises handle 92, center reinforcement 94 having holes 96, wheels 98, lock wedge 100, lock wedge connector 102, brake activator 104, spring 106, and guide piece 108. As best shown in FIG. 11, in an alternate embodiment, center reinforcement 94 having holes 96 may be provided to store handle 92 having a square cross-section configuration. Additionally, handle channel supports may also be provided in specific applications. During use, brake activator 104 may be engaged to prevent the pallet dolly from moving. When activator 104 is engaged, wedge 100 engages wheels 98 whereby the pallet dolly cannot move. If a store associate or other user needs to move the pallet dolly, brake activator 104 is disengaged which provides for wedge 100 to move away from wheel 98 thereby allowing the pallet dolly to freely travel along wheels 98.

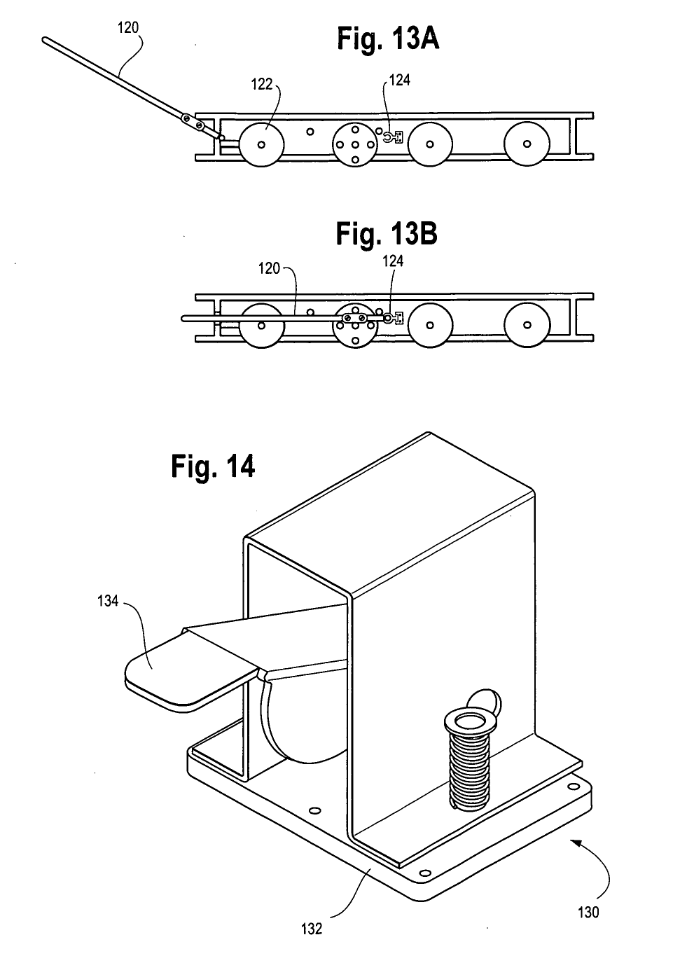

As shown in FIG. 13, alternate embodiments of the pallet dolly may provide more than four (4) wheels. As shown in FIG. 13, one version of the pallet dolly may include a total of eight (8) wheels, four on each side of the pallet dolly. Of course, other embodiments may include any number of wheels required to support the specific application of the pallet dolly and the expected loading the pallet dolly may be required to support. Also shown in FIGS. 13A and B, are an alternate storage handle assembly combination. As shown in FIGS. 13A and B, one embodiment of the pallet dolly may include handle 120, wheels 122, and handle storage support 124. FIG. 13A shows handle 120 in its removed position thereby allowing a user to easily grasp handle 120 to move the pallet dolly. FIG. 13B shows handle 120 in its stored position whereby handle 120 is engaged by handle storage support 124 to maintain handle 120 in a secure stored position inside of the pallet dolly.

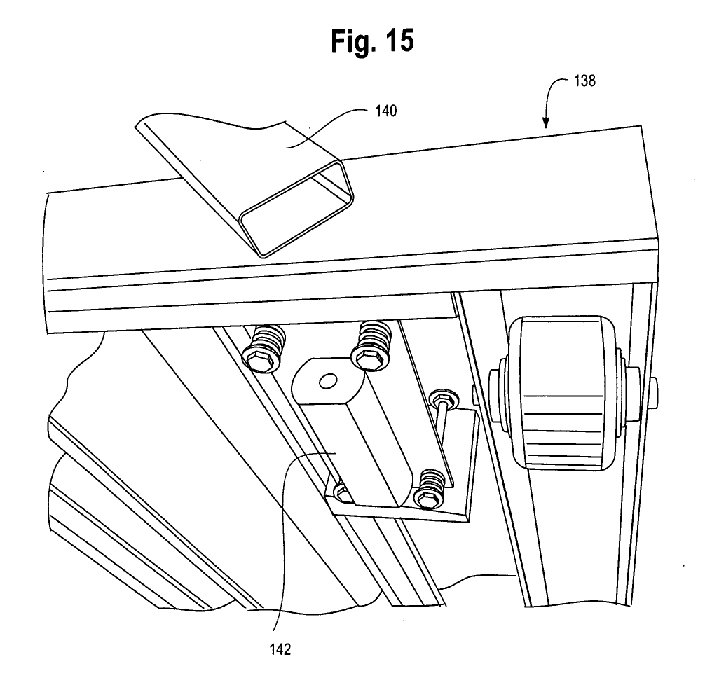

As shown in FIG. 14, an alternate embodiment of a brake assembly 130 is shown. In this form, brake assembly 130 may have friction pad 132 and brake actuation lever 134. Brake assembly 130 would be permanently or removably connected to the pallet dolly in order to provide a means for preventing the pallet dolly from moving. During use, a store associate would either use their foot, hand or other means to push down on brake lever 134 which moves friction pad 132 in a downward direction whereby friction pad 132 contacts the floor or other ground surface that the pallet dolly is positioned on. When friction pad 132 comes into contact with the ground surface, the pallet dolly is prevented from rolling on its wheels. In yet another form, as shown in FIG. 15, a brake assembly 138 may be provided which also includes a friction pad 142. In this embodiment using a friction pad, a pallet dolly handle 140 may be used to activate the brake assembly 138 or an alternate handle 140 may be used for hand operation of a brake assembly 138. In this embodiment, the similar operation occurs where friction pad 142 comes into forced contact with the ground whereby movement of the pallet dolly is prevented.

Specific embodiments of novel methods and apparatus for construction of novel pallet dollies according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

1. A pallet dolly for storage and movement of merchandise, comprising:
a deck;
a plurality of wheels rotatably connected to the deck;
a handle movably connected to the deck and whereby the handle can be stored adjacent the deck; and
a braking assembly attached to the deck.

2. The pallet dolly of claim 1 further comprising a brake lever for actuating the braking assembly.

3. The pallet dolly of claim 1 further comprising one or more wheel channels located on the underside of the deck within which one or more of the plurality of wheels are mounted.

4. The pallet dolly of claim 1 further comprising a shaft joined to one or more wheels, a gear mounted on a first end of the shaft, a brake rotor for engaging the gear whereby the brake rotor is connected to a brake lever movably attached to the deck.

5. The pallet dolly of claim 4 further including a brake cam attached to the brake rotor and whereby a spring is mounted to the brake cam to provide for alignment of the brake rotor and the gear.

6. The pallet dolly of claim 1 further comprising one or more handle channels located on the underside of the deck whereby the handle can be stored within the handle channels.

7. The pallet dolly of claim 1 wherein the deck further comprises one or more holes within which the handle can be inserted to provide for the handle to be stored within the deck.

8. The pallet dolly of claim 1 further comprising one or more pin stops to limit the movement of the brake lever.

9. The pallet dolly of claim 1 wherein the gear braking assembly further includes one or more shims mounted on the shaft adjacent one or more wheels.

10. The pallet dolly of claim 1 whereby the handle is rotatably connected to the deck and whereby the handle can be substantially stored on the undersurface of the deck.

11. The braking assembly of claim 1 comprising one or more rollers connected to one or more roller arms whereby the one or more roller arms are connected to the pallet dolly adjacent one or more wheels; and a brake actuator lever operatively connected to the one or more arms and a brake release lever for disengaging the arms.

12. The braking assembly of claim 1 comprising one or more wedge locks operatively attached to one or more wedge connectors whereby the wedge locks are positioned adjacent one or more wheels; a first,end of one or more springs attached to a first end of the one or more wedge connectors whereby the spring second end is connected to the pallet dolly, and a brake actuator lever for engaging the one or more wedge locks to move and position the wedge locks adjacent the one or more wheels to prevent movement of the one or more wheels.

13. The braking assembly of claim 1 comprising a wedge attached to a first end of a wedge connector whereby the second end of the wedge connector is connected to a brake activator lever and a spring is positioned on the wedge connector to assist the wedge to contact the one or more wheels whereby the wedge prevents movement of the one or more wheels.

14. The braking assembly of claim 1 comprising a brake lever operatively connected to one or more friction pads whereby the brake assembly is connected to the pallet dolly and provides for the brake lever to move the friction pad in a downward direction to enable the friction pad to contact the ground.

15. A pallet dolly for storage and movement of merchandise, comprising:
a deck having a plurality of wheels rotatably connected to an underside portion of the deck;
at least one handle connected to the deck whereby the deck provides for handle storage on the underside portion of the deck; and
a braking assembly attached to the underside portion of the deck.

16. The pallet dolly of claim 15 further comprising a brake lever for actuating the braking assembly.

17. The pallet dolly of claim 15 further comprising one or more wheel channels located on the underside of the deck within which one or more of the plurality of wheels are mounted.

18. The pallet dolly of claim 15 further comprising a shaft joined to one or more wheels, a gear mounted on a first end of the shaft, a brake rotor for engaging the gear whereby the brake rotor is connected to a brake lever movably attached to the deck.

19. The pallet dolly of claim 18 further including a brake cam attached to the brake rotor and whereby a spring is mounted to the brake cam to provide for alignment of the brake rotor and the gear.

20. The pallet dolly of claim 15 further comprising one or more handle channels located on the underside of the deck whereby the handle can be stored within the handle channels.

21. The pallet dolly of claim 15 wherein the deck further comprises one or more holes within which the handle can be inserted to provide for the handle to be stored within the deck.

22. The pallet dolly of claim 15 further comprising one or more pin stops to limit the movement of the brake lever.

23. The pallet dolly of claim 15 wherein the gear braking assembly further includes one or more shims mounted on the shaft adjacent one or more wheels.

24. The pallet dolly of claim 15 whereby the handle is rotatably connected to the deck and whereby the handle can be substantially stored on the undersurface of the deck.

25. The braking assembly of claim 15 comprising one or more rollers connected to one or more roller arms whereby the one or more roller arms are connected to the pallet dolly adjacent one or more wheels; and a brake actuator lever operatively connected to the one or more arms and a brake release lever for disengaging the arms.

26. The braking assembly of claim 15 comprising one or more wedge locks operatively attached to one or more wedge connectors whereby the wedge locks are positioned adjacent one or more wheels; a first end of one or more springs attached to a first end of the one or more wedge connectors whereby the spring second end is connected to the pallet dolly, and a brake actuator lever for engaging the one or more wedge locks to move and position the wedge locks adjacent the one or more wheels to prevent movement of the one or more wheels.

27. The braking assembly of claim 15 comprising a wedge attached to a first end of a wedge connector whereby the second end of the wedge connector is connected to a brake activator lever and a spring is positioned on the wedge connector to assist the wedge to contact the one or more wheels whereby the wedge prevents movement of the one or more wheels.

28. A pallet dolly for storage and movement of merchandise, comprising:
a deck;
a plurality of wheels rotatably connected to the deck;
a handle connected to the deck; and
braking means for preventing the pallet dolly from moving.
